(19) United States
(12) Patent Application Publication
(10) Pub. No.: US 2014/0288758 A1
(43) Pub. Date: Sep. 25, 2014

(54) ELECTRIC VEHICLE CONTROL DEVICE

(71) Applicant: HITACHI AUTOMOTIVE SYSTEMS, LTD., Hitachinaka-shi, Ibaraki (JP)

(72) Inventors: Keisuke Suzuki, Kawasaki-shi (JP); Toshiya Oosawa, Yokohama-shi (JP)

(73) Assignee: Hitachi Automotive Systems, Ltd., Hitachinaka-shi, Ibaraki (JP)

(21) Appl. No.: 14/361,837

(22) PCT Filed: Dec. 6, 2012
(86) PCT No.: PCT/JP2012/081676

§ 371 Date: May 30, 2014

(30) Foreign Application Priority Data
Dec. 7, 2011 (JP) 2011-267634

(51) Int. Cl. B60L 15/20

(52) U.S. Cl. CPC B60L 15/2009; B60L 2240/423
USPC 701/22

(57) ABSTRACT

It is an object of the present invention to provide a control apparatus which can achieve a compatibility between a response characteristic of a torque which coincides an acceleration demand by a driver and a reduction effect of a gear backlash. A vehicle controller 111 includes a torque variation quantity limitation control section 202 configured to limit an increase quantity per unit time of a torque of a motor driven on a basis of a motor torque command value to correspond to an accelerator manipulated variable when an accelerator stroke sensor detects that an accelerator manipulation state is changed from a non-manipulation state to a manipulation state and the motor is switched from a braking torque to a driving torque.

### TECHNICAL FIELD

The present invention relates to a control apparatus for an electrically driven vehicle.

### BACKGROUND ART

In a conventional control apparatus for an electrically driven vehicle, in a case where an effective torque which is a subtraction result of a drag torque from a motor torque is determined to enter a null torque zone of a gear backlash mechanism or determined to leave from the null torque zone, while a control time is initialized, the effective torque is restricted to a parabolic formed torque or exponential function formed torque to reduce a vibration of a gear backlash. One example on the above-explained technique is described in a Patent document 1.

### PRE-PUBLISHED DOCUMENT

### Patent Document

Patent document 1: JP 2010-215213

### DISCLOSURE OF THE INVENTION

### Task to be Solved by the Invention

In the above-described conventional apparatus, there is an industrial demand that a compatibility between a response characteristic of a torque coincident with an acceleration demand of a driver and a reduction effect of a gear backlash is desired to be achieved.

It is an object of the present invention to provide a control apparatus for an electrically driven motor vehicle which can achieve the compatibility between the response characteristic of the torque which is coincident with the acceleration demand by the driver and the reduction effect of the gear backlash.

In the control apparatus for the electrically driven vehicle according to the present invention, when an accelerator manipulation state is detected to be changed from a non-manipulation state to a manipulation state and an electrically driven motor switches a torque state from a braking torque to a driving torque, an increase quantity per unit time of the torque of the electrically driven motor driven on a basis of a motor torque command value is limited to correspond to a detected accelerator manipulation quantity (a detected accelerator manipulated variable).

### Effect of the Invention

Therefore, the control apparatus for the electrically driven vehicle according to the present invention can realize the compatibility between the response characteristic of the torque coincident with the acceleration demand by the driver and the reduction effect of the gear backlash.

### BRIEF DESCRIPTION OF THE DRAWINGS

FIG. 1 is a system configuration view of an electrically driven vehicle.

FIG. 2 is a control block diagram of a calculation of a motor torque command value in a vehicle controller 111.

FIG. 3 is a calculation map of a torque command base value T*_{base}.

FIG. 4 is a control block diagram of a torque variation quantity limitation control section 202.

FIG. 5 is a control block diagram of a torque variation quantity limitation control section 400 for a gear backlash vibration reduction.

FIG. 6 is a calculation map of a torque variation quantity limitation value.

FIG. 7 is a timing chart representing a gear backlash vibration suppression action when, during traveling, an accelerator pedal is quickly and largely manipulated in order for the vehicle to perform an abrupt acceleration from a state in which the accelerator pedal is released (or is not depressed).

FIG. 8 is a selection situation of the torque variation limitation value in the timing chart of FIG. 7.

FIG. 9 is a timing chart representing the gear backlash vibration suppression action when, during traveling, the accelerator pedal is slowly manipulated in order for the vehicle to perform a moderate acceleration from a state in which the accelerator pedal is released (or is not depressed).

FIG. 10 is a view of a selection situation of the torque variation limitation value in the timing chart of FIG. 9.

### DESCRIPTION OF THE EMBODIMENTS

Hereinafter, preferred embodiments of a control apparatus for an electrically driven vehicle will be described with reference to the accompanied drawings. It should be noted that the preferred embodiments described hereinbelow are discussed so as to meet many needs and an achievement of an acceleration performance in accordance with an acceleration demand of a vehicle driver is one of the needs to be discussed.

### Embodiment 1

First, a structure will be described.

### [Whole Structure]

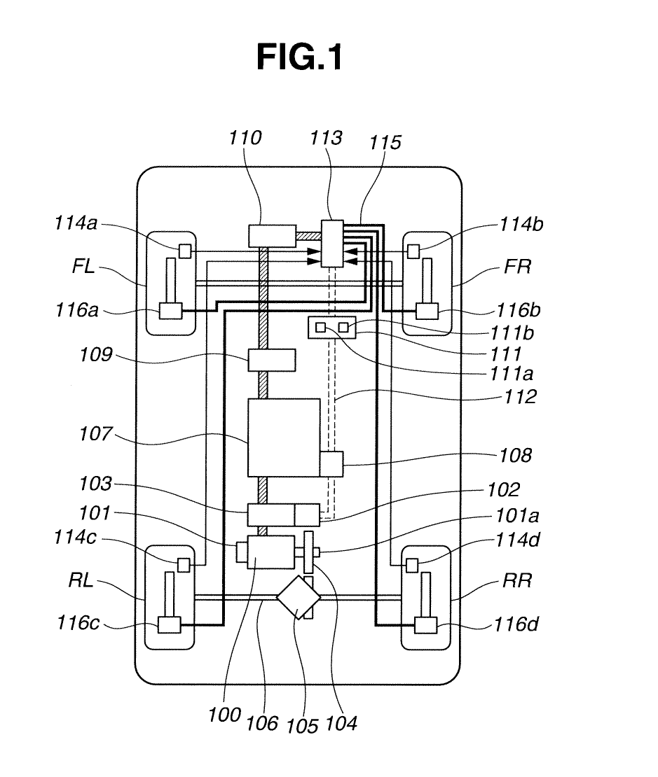

FIG. 1 shows a system configuration view of an electrically driven vehicle in a first preferred embodiment according to the present invention.

The electrically driven vehicle in the first embodiment includes an electrically driven motor (hereinafter, also referred simply to as a motor) 100 which generates a positive torque or a negative torque. A resolver as a revolution sensor (motor revolution speed calculating section) 101 is connected to motor 100. A motor controller 102 outputs a drive signal to inverter 103 by referring to the information of revolution sensor 101. Inverter 103 supplies an electric current in accordance with the drive signal to motor 100 to control a motor torque.

An output shaft 100a of motor 100 is connected to a speed reduction gear (a gear transmission mechanism) 104 to transmit a torque to a vehicle axle 106 via a differential gear (the gear transmission mechanism) 105.

An electric power to drive motor 100 is supplied from a high voltage battery (a battery) 107. A charged state and a magnitude of a heat generation are monitored by means of a battery controller 108. A DC-DC converter 109 is connected to high voltage battery 107 in order for DC-DC converter 109 to step down the voltage of high voltage battery 107 to charge a low voltage battery 110.

A vehicular controller (control unit) 111 monitors a stroke (manipulated variable) of a brake pedal (not shown) and an accelerator pedal through a brake stroke sensor 11a and accelerator stroke sensor (accelerator manipulation state detection section, an accelerator manipulated variable detecting section) 111b and transmits a positive or negative torque command to a braking control device 113 via an in-vehicle communication line 112.

Braking control device 113 performs a torque control such as a driving slip prevention control (TCS control), a braking slip prevention control (ABS control), or so forth from each road wheel speed information from road wheel speed sensors 114a, 114b, 114c, 114d installed on each road wheel FL, FR, RL, RR and the motor torque information outputted by motor controller 102.

Braking control device 113, in a case where a frictional braking torque is controlled, actuates a pump (not shown) within braking control device 113 in accordance with a pedal depression force of a vehicle driver to supply a braking liquid to each brake caliper 116a, 116b, 116c, 116d installed on a corresponding road wheel FL, FR, RL, RR via a hydraulic pressure piping 115 to generate a braking torque. On the other hand, in a case where the motor torque is controlled, braking control device 113 gives a torque command to motor controller 102 via in-vehicle communication line 112.

[Torque Variation Quantity Limitation During Zero Point Passage]

In the electrically driven vehicle in the first embodiment, a torque variation quantity in a case where the motor torque is commanded after the motor torque passage through zero is limited to be small in order to achieve a reduction of a gear backlash vibration, the backlash vibration of the gear (speed reduction gear 104, differential gear 105) being generated when the motor torque passes zero.

In the first embodiment, in a case where a demand torque of the driver is large or in a case where an increase in the torque demand is quick, the limitation of the torque variation quantity when the motor torque passes a zero torque is varied in accordance with a magnitude of the demand torque and a speed of the demand torque in order to achieve a response characteristic of the torque which accords with the acceleration demand by the driver. To achieve the torque variation limitation, vehicle controller 111 calculates a motor torque command value which drives motor 100 in the following method.

It should be noted that the torque variation quantity generated at a level by which the gear backlash vibration is recognized by the driver, namely, the level of unpleasant feeling to the driver is different according to specifications of the vehicle. In the first embodiment, the torque variation quantity is described as equal to or larger than 20 Nm/sec.

[Motor Torque Command Value Calculation]

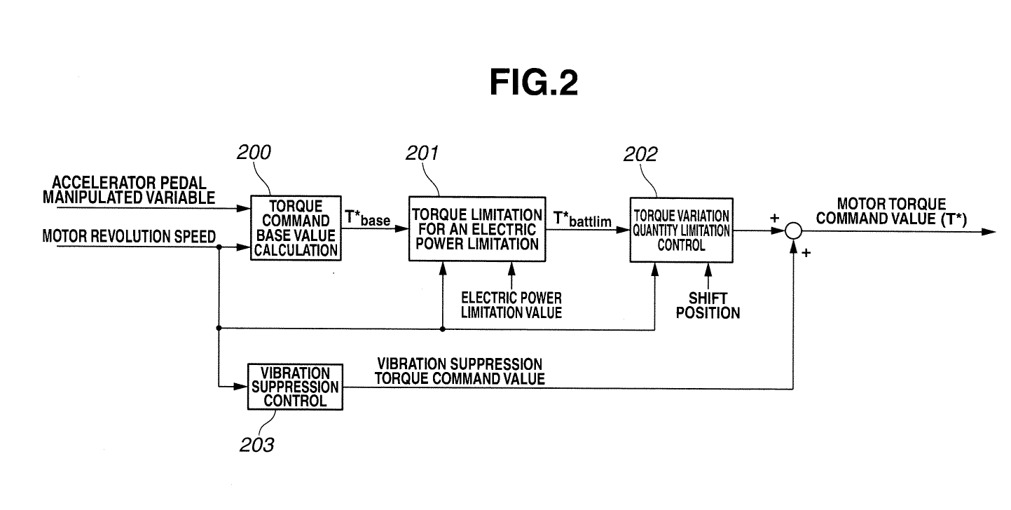

FIG. 2 shows a control block diagram of a motor torque command value calculation in vehicle controller 111.

A torque command base value calculation section (motor torque command base value calculation section) 200 calculates a torque command base value T*_{base} on a basis of an accelerator manipulated variable and a motor revolution speed.

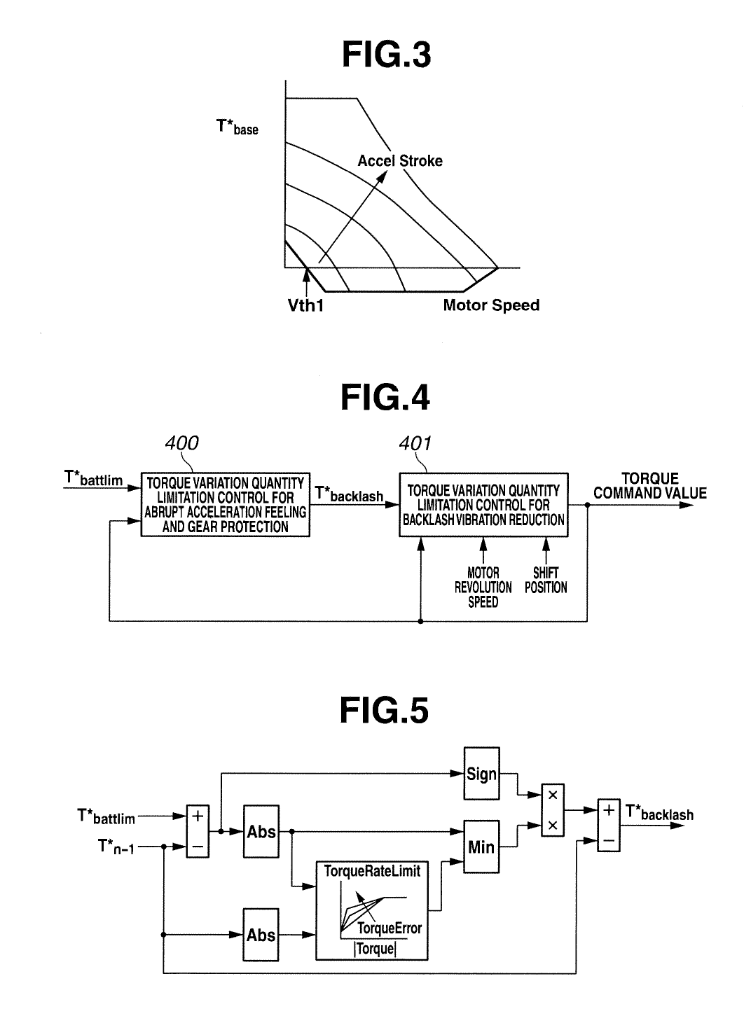

FIG. 3 shows a calculation map of torque command base value T*_{base}. Torque command base value T*_{base} is such that an advance torque (a positive torque) becomes larger as the motor revolution speed becomes lower (a vehicle speed becomes lower) and as the accelerator manipulated variable becomes larger. In addition, in a case where the accelerator manipulated variable indicates zero, in a region of a vehicle speed equal to or lower than a predetermined speed (for example, 5 Km/h) in which the vehicle is stopped and is traveling at a low speed, the advance torque (positive torque) is made larger as the vehicle speed (≈motor revolution speed) becomes lower, in order to simulate a creep torque of an automatic transmission mounted vehicle. In a speed region in which the vehicle speed exceeds the predetermined speed Vth1, a reverse torque (a negative torque) is given in order to simulate an engine brake torque. A torque limitation section for an electric power restriction (a motor torque command base value correction section) 201 calculates a post-correction torque command base value T*_{battlim} to which torque command base value T_{base} is limited accordance with an electric power limitation value in order to provide a motor output in a range which does not exceed an electric power limitation value calculated by battery controller 108.

A torque variation quantity limitation control section (a motor torque variation quantity limitation control section) 202, as shown in FIG. 4, includes a torque variation quantity limitation control section 400 for a backlash vibration reduction; and a torque variation quantity limitation control section 401 for abrupt acceleration feeling prevention and a gear protection.

FIG. 5 shows a control block diagram of torque variation quantity limitation control section 400 for the backlash vibration reduction.

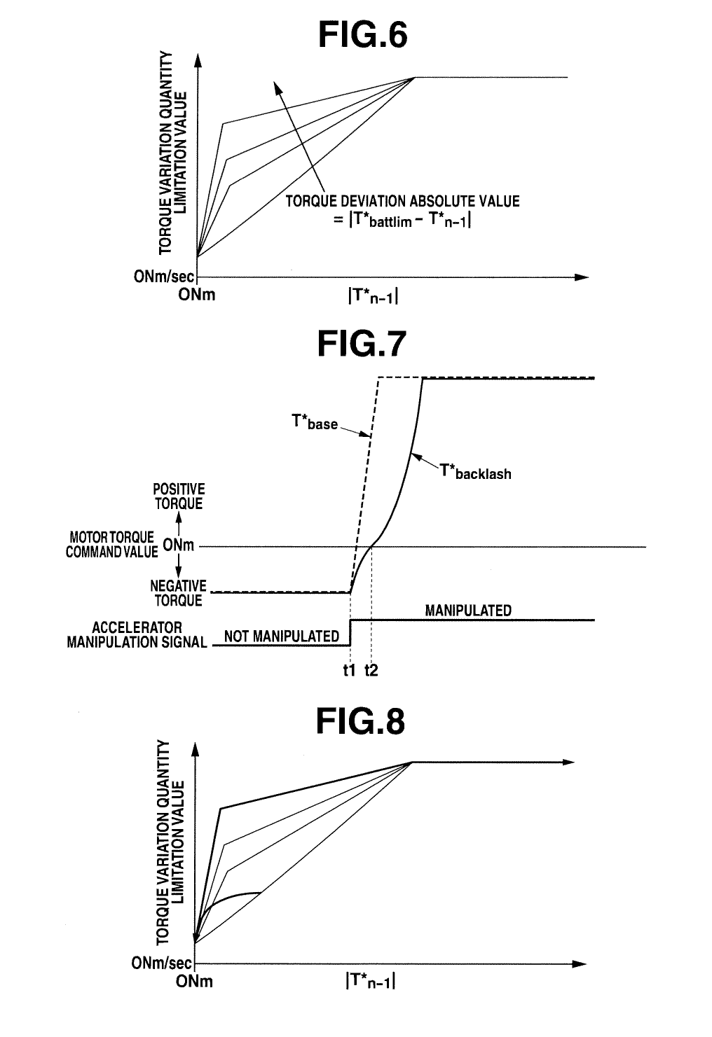

Input signals thereof are a post-correction torque command base value T*_{battlim} outputted from torque limitation section 201 for the electric power limitation and a final torque command value T*ₙ₋₁ at a previous control period (T*ₙ₋₁ can be deemed to be an actual torque which is presently being outputted). In the blocks shown in FIG. 5, “Abs” denotes an output of an absolute value for an input, “Sign” denotes the output of a sign signal (positive=1, negative=−1). “Min” denotes an output of a smaller value for the inputs and “1/Z” denotes storing a value before one control period. In details, torque variation quantity limitation control section 400 for the backlash vibration reduction calculates a difference between post-correction torque command base value T*_{battlim} and final torque command value T*ₙ₋₁ at the previous control period, namely, limits an upper limit of an increase quantity per unit time of the torque by a torque variation quantity limitation value calculated from a map shown in FIG. 6 and calculates a new torque command value T*_{backlash} by adding this limited value to a final torque command value T*ₙ₋₁ at the previous control period.

FIG. 6 is a two-dimensional map for calculating the torque variation quantity limitation value.

To derive the torque variation quantity limitation value, final torque command value T*ₙ₋₁ at the previous control period and the difference between post-correction torque command base value T*_{battlim} and final torque command value T*ₙ₋₁ at the previous control period are inputted.

At this time, the calculated torque variation quantity limitation value is set to be smaller as an absolute value |T*ₙ₋₁| (a torque command absolute value) of final torque command value T*ₙ₋₁ at the previous control period becomes smaller and to be smaller as an absolute value |T*_{battlim}−T*ₙ₋₁| (a torque deviation absolute value) of the difference between the corrected torque command base value T*_{battlim} and final torque command value T*ₙ₋₁ at the previous control period becomes smaller.

It should be noted that in a case where the accelerator manipulated variable becomes larger, the value of T*ₙ₋₁ becomes larger and, hence, the torque variation quantity limitation value is accordingly large. In addition, as an accelerator manipulation speed becomes higher, the difference between T*_{battlim} and T*ₙ₋₁ becomes larger so that the torque variation limitation value becomes larger. That is to say, the map shown in FIG. 6 has a characteristic such that, as the accelerator manipulated variable becomes larger or the acceleration manipulation speed becomes higher, the increase quantity of the torque per unit time (an increase gradient) becomes larger. It should be noted that, since the difference between T*_{battlim} and T*ₙ₋₁ is a value approximated to the accelerator manipulation speed, torque variation quantity limitation control section 400 for the backlash vibration reduction corresponds to an accelerator manipulation speed calculation section.

Torque variation quantity limitation control section 401 for the abrupt acceleration feeling and gear protection performs a process such that the torque variation quantity is limited to a value equal to or below a predetermined value on a basis of the motor revolution speed and a shift position of a transmission in order to protect gears of a power train due to an abrupt change in the motor torque and in order not to give an unpleasant feeling to the driver involved in the torque variation.

Referring back to FIG. 2, a vibration suppression control section 203 calculates a vibration suppression torque command value to suppress the vibration such as a torque ripple involved in the revolution of the motor. The vibration suppression torque command value is added to the torque command value after the torque variation quantity limitation by means of torque variation quantity limitation control section 202 to derive a final motor torque command value T*.

Motor torque command value T* is supplied to motor controller 102 via in-vehicle communication line 112.

Next, an action will be described.

### [Gear Backlash Vibration Suppression Action]

In Patent document 1, in order to reduce the gear backlash vibration, in a case where the effective torque which is the subtraction of the drag torque from the motor torque is determined to enter the null torque zone of the gear backlash mechanism or determined to leave from the null torque zone, while the control time is initialized, the effective torque is limited to the torque of parabolic formed or exponential function formed torque. However, in this conventional technique, a time to limit the torque to parabolic or exponential function formed torque is determined (fixed). Hence, in a case where, for example, an abrupt acceleration is demanded, the torque is limited for the time which is the same in the case where the abrupt acceleration is not demanded.

In order words, in spite of a degree of the acceleration that the driver has demanded, the torque is always limited for the same time. Hence, at a time of the abrupt acceleration demand, the acceleration that the driver has desired cannot be obtained.

On the other hand, in the first embodiment, in a case where the accelerator pedal is again manipulated to accelerate the vehicle (namely, the positive torque is demanded) from a negative torque which simulates the engine brake developed when the accelerator pedal is released during the traveling of the vehicle, an increase gradient of the torque that the driver demands is large and the depression quantity (manipulated variable of the accelerator pedal) is large. At this time, since a large torque variation quantity limitation value is selected according to the map shown in FIG. 6, a rise gradient of the torque is large as compared with a case where the accelerator pedal is moderately manipulated.

That is to say, in a case where the driver has an intention to abruptly accelerate the vehicle, a delay time for the acceleration demand by the driver can be shortened in place of the reduction of the reduction effect of the gear backlash vibration. At this time, although the gear backlash vibration is generated, the driver does not give the unpleasant feeling since it is during the abrupt acceleration.

In addition, in the first embodiment, if the rise gradient of the torque that the driver has demanded is small, the difference between T*_{battlim} and final torque command value T*ₙ₋₁ at the previous control period as inputs shown in FIG. 6 is not large. Thus, the torque variation quantity limitation value becomes small. Thus, in a case where the driver desires the moderate acceleration, the torque having a small variation quantity passes zero torque. Consequently, the suppression effect of the gear backlash vibration can sufficiently be obtained.

As described above, since, in the first embodiment, the response characteristic of the torque and the gear backlash reduction effect in accordance with the degree of the acceleration demand by the driver are compatible so that the torque delay time with respect to the abrupt acceleration demand can be shortened without giving the driver the unpleasant feeling.

Hereinafter, the gear backlash vibration suppression control action in the first embodiment will be described using a specific traveling scene.

FIG. 7 shows a timing chart representing a backlash vibration suppression action when the accelerator pedal is quickly and deeply depressed in order to provide the vehicle for the abrupt acceleration from a state in which the accelerator pedal is released, during a traveling of the vehicle. FIG. 8 shows a selection situation of the torque variation quantity limitation value to suppress the gear backlash vibration in this case.

At a time point t1, since the vehicle driver starts the depression of the accelerator pedal, a rise of T*_{battlim} is started. At this time, according to the difference between T*_{battlim} and T*ₙ₋₁, torque variation quantity limitation value is selected in accordance with the map shown in FIG. 8. Thereafter, as T*ₙ₋₁ approaches zero, although the difference between T*_{battlim} and T*ₙ₋₁ becomes large, the torque variation quantity limitation value becomes decreased since T*ₙ₋₁ becomes small.

At a time point t2, smallest torque variation quantity limitation value is selected since T*ₙ₋₁ becomes decreased and reaches to zero. After the passage of zero torque in accordance with the selected torque variation limitation value, the difference between T*_{battlim} and T*ₙ₋₁ becomes large. Hence, if the torque variation quantity is limited in accordance with the characteristic such that the largest limitation value is selected as in FIG. 8, the difference between T*_{battlim} and T*ₙ₋₁ is decreased.

As described above, in a case where the driver demands the abrupt acceleration, a relatively large torque variation limitation value is selected so that a quick rise of the torque can be achieved. That is to say, since a response delay time of the torque can be shortened, the driver becomes difficult to notice the torque delay.

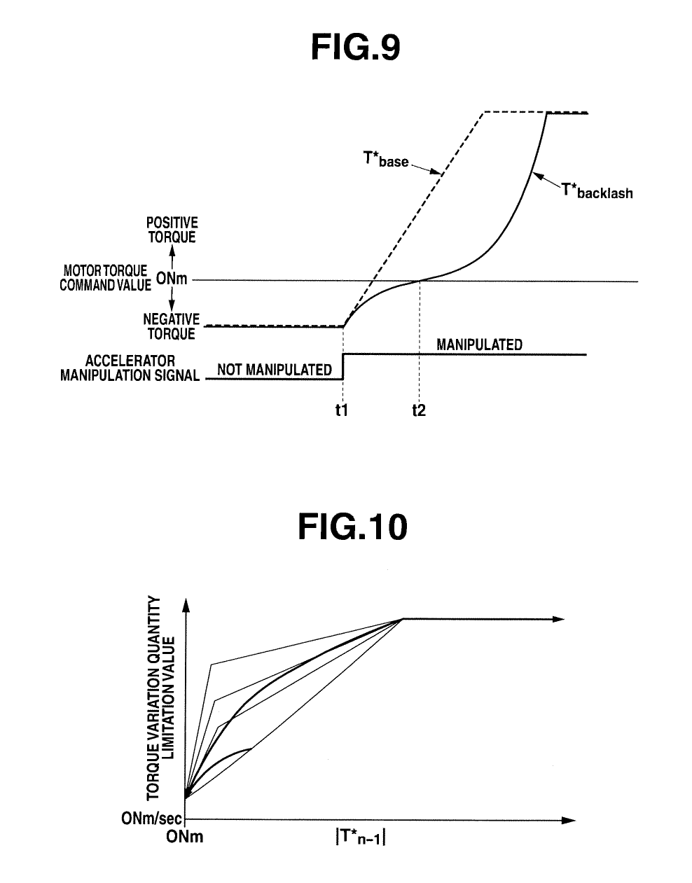

FIG. 9 shows a timing chart representing the gear backlash vibration suppression action when the accelerator pedal is slowly manipulated in order to moderately accelerate the vehicle from the state in which the driver releases the accelerator pedal during the traveling of the vehicle.

FIG. 10 shows the selection situation of the torque variation quantity limitation value to reduce the gear backlash vibration suppression in this case.

At time point t1, the value of T*_{battlim} is started to rise since the driver starts the depression of the accelerator pedal. At this time, since the torque rise gradient is small, the difference between T*_{battlim} and becomes small so that a smallest limitation value of FIG. 10 is selected as the torque variation quantity limitation value.

Thereafter, as T*ₙ₋₁ approaches zero, although the difference between T*_{battlim} and T*ₙ₋₁ becomes increased, the torque variation quantity limitation value becomes decreased since T*ₙ₋₁ becomes small.

At a time point t2, the smallest torque limitation value is selected since T*ₙ₋₁ is decreased to zero.

After the passage of zero torque in accordance with the selected torque variation limitation value, the torque variation quantity limitation value is selected in accordance with the map shown in FIG. 10 according to the difference between T*_{battlim} and T*ₙ₋₁ so that the difference between T*_{battlim} and T*ₙ₋₁ is moderately decreased.

As described above, in a case where the driver demands the moderate acceleration, a relatively small torque variation quantity limitation value is selected so that the moderate rise in the torque can be achieved. In other words, since the time for which the torque passes through the proximity of zero torque can be elongated, the gear backlash vibration can become difficult to be generated.

Next, an effect will be explained.

The control apparatus for the electrically driven vehicle in the first embodiment has the following effects.

(1) The control apparatus for the electrically driven vehicle, comprises: accelerator stroke sensor 111b configured to detect the accelerator manipulation state of the driver and the accelerator manipulated variable; motor 100 configured to provide braking and driving torques for rear left and right road wheels RL, RR connected via speed reduction gear 104 and differential gear 105; and vehicular controller 111 configured to calculate the motor torque command value to brake and drive motor 100 on a basis of the accelerator manipulated variable detected by accelerator stroke sensor 111b, wherein vehicular controller 111 comprises torque variation quantity limitation control section 202 configured to limit the increase quantity per unit time of the torque of motor 100 driven on a basis of motor torque command value T* when the accelerator stroke sensor 111b detects that the accelerator manipulation state is changed from an non-manipulation state to the manipulation state and the motor 100 switches the torque state from the braking torque to the driving torque.

Thus, the compatibility of the response characteristic of the torque which coincides with the acceleration demand by the driver and the reduction effect of the gear backlash vibration can be achieved.

(2) Torque variation quantity limitation control section 202 increases the increase quantity of the torque per unit time when the detected accelerator manipulated variable is large (when T*ₙ₋₁ is large) as compared with the case when the detected accelerator manipulated variable is small.

Thus, in a case where the driver demands the abrupt acceleration of the vehicle, the delay time of the torque is short and, in a case where the driver demands the moderate acceleration of the vehicle, the delay time of the torque is long. Consequently, the compatibility between the response characteristic of the torque which meets the acceleration demand by the vehicle driver and the reduction effect of the gear backlash can be achieved at a high level.

(3) Torque variation quantity limitation control section 202 enlarges the increase quantity per unit time of the torque when the calculated accelerator manipulation speed is high (when the difference between T*_{battlim} and T*ₙ₋₁ is large) as compared with a case where the calculated accelerator manipulation speed is low.

Thus, the delay time of the torque is short, in a case where the driver demands the abrupt acceleration and, in a case where the driver demands the moderate acceleration, the delay time of the torque is long. Consequently, the compatibility between the response characteristic of the torque which coincides with the acceleration demand by the vehicle driver and the reduction effect of the gear backlash can be achieved at the high level.

(4) The control apparatus further comprises a revolution sensor 101 configured to calculate a revolution speed of motor 100, vehicular controller 111 comprises torque command base value calculation section 200 configured to calculate a torque command base value T*_{base} on a basis of the detected accelerator manipulated variable and the calculated motor revolution speed, and limits the torque of motor 100 by adjusting calculated torque command base value T*_{base}.

Thus, the increase quantity per unit time of the torque of motor 100 can be limited to a desired increase quantity by adjusting torque command base value T*_{base}.

(5) The vehicular controller 111 includes a torque limitation section 201 for an electric power limitation configured to correct calculated torque command base value T*_{base} in accordance with the state of high voltage battery 107 torque variation quantity limitation control section 202 drives motor 100 using a torque command value T*_{backlash} which is an addition of a difference between torque command base value T*_{battlim} corrected by torque limitation section for the electric power limitation 201 and final torque command value T*ₙ₋₁ at a previous control period to final torque command value T*ₙ₋₁ at the previous control period. Thus, since the motor output is suppressed to a range in which the motor output does not exceed the power limitation value, motor 100, inverter 103, and high voltage battery 107 can be suppressed so as not to be overloaded and an improvement in a durability can be achieved.

### Other Embodiments

As described hereinabove, the control apparatus in the first embodiment has been described. However, a specific structure of the present invention is not limited to the first embodiment. Design modifications in a range without departing from the gist of the invention may be included in the present invention.

In the first embodiment, even if the difference between T*_{battlim} and T*ₙ₋₁ is large in the map shown in FIG. 6, a minimum (smallest) torque variation limitation value is selected when T*ₙ₋₁ is zero. For example, when the difference between T*_{battlim} and T*ₙ₋₁ is large, the torque variation quantity limitation value may not be decreased to the minimum value even when T*ₙ₋₁ is zero.

In the first embodiment, T*ₙ₋₁ is referred to. However, this may be a measured value of a sensor for measuring the torque applied to the gear or a torque estimation signal.

The torque variation quantity limitation value selected when T*ₙ₋₁ is a value near to zero and the difference between T*_{battlim} and T*ₙ₋₁ is small may be equal to or below the torque variation quantity which can be suppressed to a level that the gear backlash vibration is not recognized to the driver.

In the first embodiment, the torque variation quantity is limited to suppress the vibration to be developed in the proximity of zero torque due to the gear backlash. However, the present invention may be applied to a torque region in which the vibration of the power train or the vehicle is generated due to another factor.

Hereinafter, technical ideas of the invention graspable from the first embodiment and other than the invention described in the claims will be explained.

(a) The control apparatus for the electrically driven motor vehicle as set forth in claim 5, wherein the motor torque variation quantity limitation control section decreases the increase quantity per unit time of the torque of the electrically driven motor driven on a basis of the motor torque command value as the previously calculated corrected motor torque command base value becomes smaller.

The previously calculated corrected motor torque command base value is a value representing an actual motor torque. As this value becomes smaller, it can be determined that the driver demands a moderate acceleration. Hence, as the previously calculated corrected motor torque command value becomes smaller, the increase quantity per unit time of the torque is made smaller (decreased). Thus, the compatibility between the response characteristic of the torque which meets the driver's acceleration demand and the reduction effect of the gear backlash can be realized at the high level.

(b) The control apparatus for the electrically driven vehicle as set forth in claim 5, wherein the motor torque variation quantity limitation control section decreases (make smaller) the increase quantity per unit time of the torque of the electrically driven motor driven on a basis of the motor torque command value as the difference between the motor torque command base value corrected by the motor torque command base value correcting section and the previously calculated corrected motor torque command base value becomes smaller.

The above-described difference is a value indicating an accelerator manipulation speed. As this value becomes smaller, it can be determined that the driver demands the moderate acceleration. Hence, as the difference becomes smaller, the increase quantity per unit time of the torque is made smaller (decreased). Consequently, the compatibility between the response characteristic of the torque which coincides with the driver's acceleration demand and the reduction effect of the gear backlash can be realized at the high level.

(c) The control apparatus for the electrically driven vehicle as set forth in claim 5, wherein the motor torque variation quantity limitation control section decreases the increase quantity per unit time of the torque of the electrically driven motor driven on a basis of the motor torque command base value in a case where the previously calculated corrected motor torque command base value is small and as the difference between the motor torque command base value corrected by the motor torque command base value correcting section and the previously calculated corrected motor torque command base value becomes smaller.

The previously calculated corrected motor torque command base value is a value representing an actual motor torque. As this value becomes smaller, it can be determined that the driver demands the moderate acceleration. In addition, the above-described difference is a value representing the accelerator manipulation speed. As this value becomes smaller, the accelerator manipulation speed becomes low and it can be determined that the driver demands the moderate acceleration. Hence, as the previously calculated corrected motor torque command base value becomes smaller, the increase quantity per unit time of the torque is made smaller (decreased) or the increase quantity per unit time of the torque is made smaller as the difference becomes smaller. Then, the compatibility between the response characteristic of the torque which coincides with the driver's acceleration demand and the reduction effect of the gear backlash can be realized at the high level.

(d) The control apparatus for the electrically driven vehicle as set forth in claim 1, which further comprises a motor revolution speed calculating section configured to calculate a revolution speed of the electrically driven motor, wherein the control unit further comprises a vibration suppression control section configured to calculate a vibration suppression torque command value to suppress the vibration of the electrically driven motor on a basis of the calculated motor revolution speed, and wherein the motor torque variation quantity limitation control section limits the motor torque on a basis of a command value which is an addition of the vibration suppression torque command value to the calculated motor torque command value.

Thus, the gear in the power train can be protected from an abrupt change of the motor torque and a suppression of giving an unpleasant feeling to the driver involved in a torque variation can be achieved.

(e) A control apparatus for an electrically driven vehicle, comprising:

an accelerator manipulation state detecting section configured to detect an accelerator manipulation state of a is driver;

an accelerator manipulated variable detecting section configured to detect an accelerator manipulated variable of the driver;

an electrically driven motor providing a braking torque and a driving torque for road wheels connected via a speed reduction mechanism and a wheel axle; and

a control unit configured to calculate a motor torque command value to brake and drive the electrically driven motor on a basis of the accelerator manipulated variable detected by the accelerator manipulated variable detecting section, wherein the control unit comprises a motor torque variation quantity limitation control section configured to make smaller an increase gradient of the torque of the electrically driven motor driven on a basis of the motor torque command value than the increase gradient according to the calculated motor torque command value on a basis of the detected accelerator manipulated variable when the torque generated by the electrically driven motor is switched from the torque in a braking direction to that in a driving direction.

Thus, the compatibility between the response characteristic of the torque which meets the driver's acceleration demand and the reduction effect of the gear backlash can be achieved.

(f) The control apparatus for the electrically driven vehicle as set forth in item (e), wherein the motor torque variation quantity limitation control section enlarges the increase quantity per unit time of the torque when the detected accelerator manipulated variable is large as compared with a case where the accelerator manipulated variable is small.

Thus, the delay time of the torque in a case where the driver demands the abrupt acceleration is short and, in a case where the driver demands the moderate acceleration, the delay time of the torque is long. Consequently, the compatibility between the response characteristic of the torque which coincides with the driver's acceleration demand and the reduction effect of the gear backlash can be realized at the high level.

(g) The control apparatus for the electrically driven vehicle as set forth in item (e), which further comprises an accelerator manipulation speed calculating section configured to calculate an accelerator manipulation speed and wherein the motor torque variation quantity limitation control section enlarges the increase quantity per unit time of the torque in a case where the calculated accelerator manipulation speed is high as compared with a case where the calculated accelerator manipulation speed is low.

Thus, since the delay time of the torque is short in a case where the driver demands the abrupt acceleration and the delay time of the torque is long in a case where the driver demands the moderate acceleration, the compatibility between the response characteristic of the torque which coincides with the acceleration demand of the driver and the reduction effect of the gear backlash can be realized at the high level.

(h) The control apparatus for the electrically driven vehicle as set forth in item (e), which further comprises a motor revolution speed calculating section configured to calculate a revolution speed of the electrically driven motor, wherein the control unit comprises a motor torque command base value calculating section configured to calculate the motor torque command base value on a basis of the detected accelerator manipulated variable and is the calculated motor revolution speed, and wherein the motor torque variation quantity limitation control section limits the calculated motor torque command base value to drive the electrically driven motor.

Hence, by limiting the motor torque command base value, the increase gradient of the torque of the electrically driven motor can be limited to a desired gradient.

(i) The control apparatus for the electrically driven vehicle as set forth in item (h), wherein the control unit further comprises a motor torque command base value correcting section configured to correct the calculated motor torque command base value in accordance with a state of an electrically driven motor driving purpose battery and wherein the motor torque variation quantity limitation control section adds the difference between the motor torque command base value corrected by the motor torque command base value correcting section and the previously calculated corrected motor torque command base value to the previously corrected motor torque command base value to calculate the motor torque command value to limit the torque of the electrically driven motor.

Thus, the output of the motor can be corrected in accordance with the state of the battery.

(j) The control apparatus for the electrically driven vehicle as set forth in item (i), wherein the motor torque variation quantity limitation control section makes smaller the increase gradient of the torque of the electrically driven motor driven on a basis of the motor torque command value as the previously calculated corrected motor torque command base value becomes smaller.

Thus, the previously calculated corrected motor torque command base value is a value representing an actual motor torque. As this value becomes smaller, it can be determined that the driver demands the moderate acceleration. Hence, the increase gradient of the torque is made smaller as the previously calculated corrected motor torque command base value becomes smaller.

Consequently, the compatibility between the response characteristic of the torque which meets the acceleration demand of the driver and the reduction effect of the gear backlash can be realized at the high level.

(k) The control apparatus for the electrically driven vehicle as set forth in item (j), wherein the motor torque variation quantity limitation control section makes smaller (decreases) the increase gradient of the torque of the electrically driven motor driven on a basis of the motor torque command value as the difference between the motor torque command base value corrected by the motor torque command base value correcting section and the previously calculated corrected motor torque command base value becomes smaller.

Hence, the above-described difference is a value representing the accelerator manipulation speed and, as this value becomes smaller, the accelerator manipulation speed becomes lower and it can be determined that the driver demands the moderate acceleration. Thus, the difference becomes smaller, the increase gradient of the torque becomes smaller. Consequently, the compatibility between the response characteristic of the torque which meets the acceleration demand of the driver and the reduction effect of the gear backlash can be realized at the high level.

(l) The control apparatus for the electrically driven vehicle as set forth in item (j), wherein the control unit comprises a vibration suppression control section configured to calculate a vibration suppression torque command value to suppress the vibration of the electrically driven motor on a basis of the calculated motor revolution speed and wherein the motor torque variation quantity limitation control section limits the increase gradient of the motor torque on a basis of the command value which is an addition of the vibration suppression torque command value to the calculated motor torque command value.

Hence, the gear in the power train can be protected from the abrupt change in the motor torque and the suppression of the unpleasant feeling given to the driver involved in the torque variation can be achieved.

(m) A control method for an electrically driven vehicle, the control method driving an electrically driven motor which provides a driving torque for road wheels connected via a speed reduction mechanism and a wheel axle on a basis of an accelerator manipulation state and comprising: providing a braking torque for the road wheel axle when an acceleration manipulation is not carried out from an accelerator manipulation related information detecting section configured to detect an accelerator manipulation related information of a driver and, thereafter, providing a driving torque for the road wheels at an increase gradient smaller than the driving torque when the acceleration manipulation state is transferred to a state in which the accelerator manipulation is carried out.

Therefore, the gear backlash vibration when the torque passes a zero torque can be suppressed.

(n) The control method for the electrically driven vehicle as set forth in item (m), wherein the increase quantity per unit time of the torque is enlarged when the accelerator manipulated variable from among the accelerator manipulation related information is large as compared with a case where the accelerator manipulated variable is small. Thus, the delay time of the torque in a case where the driver demands the abrupt acceleration is short and the delay time of the torque in a case where the driver demands the moderate acceleration is long. Consequently, the compatibility between the response characteristic of the torque which meets the acceleration demand of the driver and the reduction effect of the gear backlash can be realized at the high level.
(o) The control method for the electrically driven vehicle as set forth in item (m), wherein the increase quantity per unit time of the torque is enlarged when an accelerator manipulation speed is high as compared with a case where the accelerator manipulation speed is low.

Thus, the delay time of the torque in a case where the driver demands the abrupt acceleration is short and the delay time of the torque in a case where the driver demands the moderate acceleration is long. Consequently, the compatibility between the response characteristic of the torque which coincides with the acceleration demand of the driver and the reduction effect of the gear backlash can be realized at the high level.

### EXPLANATION OF SIGNS

100 electrically driven motor
104 speed reduction gear (gear transmission mechanism)
105 differential gear (gear transmission mechanism)
111 vehicular controller (control unit)
111b accelerator stroke sensor (accelerator manipulation state detecting section, accelerator manipulated variable detecting section)
202 Torque variation quantity limitation control section (motor torque variation quantity limitation control section)
RL, RR left and right front wheels (road wheel axle)

1. A control apparatus for an electrically driven vehicle, comprising: an accelerator manipulation state detecting section configured to detect an accelerator manipulation state of a driver;
an accelerator manipulated variable detecting section configured to detect an accelerator manipulated variable of the driver;
an electrically driven motor configured to provide a braking torque and a driving torque for road wheels connected via a gear transmission mechanism; and
a control unit configured to calculate a motor torque command value to perform a braking and a driving for the electrically driven motor on a basis of the accelerator manipulated variable detected by the accelerator manipulated variable detecting section, wherein the control unit comprises a motor torque variation quantity limitation control section configured to limit an increase quantity per unit time of the torque the electrically driven motor driven on a basis of the motor torque command value to correspond to the detected accelerator manipulated variable when the accelerator manipulation state detecting section detects that the accelerator manipulation state has changed from a non-manipulation state to the manipulation state and when the electrically driven motor has switched a torque state from the braking torque to the driving torque.

2. The control apparatus for the electrically driven vehicle as claimed in claim 1, wherein the motor torque variation quantity limitation control section enlarges the increase quantity per unit time of the torque when the detected accelerator manipulated variable is large as compared with a case when the detected accelerator manipulated variable is small.

3. The control apparatus for the electrically driven vehicle as claimed in claim 1, which further comprises an accelerator manipulation speed calculating section configured to calculate an accelerator manipulation speed and wherein the motor torque variation quantity limitation control section enlarges the increase quantity per unit time of the torque when the calculated accelerator manipulation speed is high as compared to a case where the calculated accelerator manipulation speed is low.

4. The control apparatus for the electrically driven vehicle as claimed in claim 1, which further comprises a motor revolution speed calculating section configured to calculate a revolution speed of the electrically driven motor, wherein the control unit further comprises a motor toque command base value calculating section configured to calculate the motor torque command base value on a basis of the detected accelerator manipulated variable and the calculated motor revolution speed, and the motor torque variation quantity limitation section limits the torque of the electrically driven motor by adjusting the calculated motor torque base value.

5. The control apparatus for the electrically driven vehicle as claimed in claim 4, wherein the control unit further comprises a motor torque command base value correcting section configured to correct the calculated motor torque base value in accordance with a state of a battery for an electrically driven motor drive purpose and wherein the motor torque variation quantity limitation control section drives the electrically driven motor using the motor torque command value which is an addition of a difference between the motor torque command base value corrected by the motor torque command base value correcting section and the previously calculated corrected motor torque command base value to the previously corrected motor torque command base value.

6. The control apparatus for the electrically driven vehicle as claimed in claim 5, wherein the motor torque variation quantity limitation control section decreases the increase quantity per unit time of the torque of the electrically driven motor driven on a basis of the motor torque command value as the previously calculated corrected motor torque command base value becomes smaller.

7. The control apparatus for the electrically driven vehicle as claimed in claim 5, wherein the motor torque variation quantity control section decreases the increase quantity per unit time of the torque of the electrically driven motor driven on a basis of the motor torque command value as a difference between the motor torque command base value corrected by the motor torque command base value correcting section and the previously calculated corrected motor torque command base value becomes smaller.

8. The control apparatus for the electrically driven vehicle as claimed in claim 5, wherein the motor torque variation quantity limitation control section decreases the increase quantity per unit time of the torque of the electrically driven motor driven on a basis of the motor torque command value in a case where the previously calculated corrected motor torque command base value is small and as the difference between the motor torque command base value corrected by the motor torque command value correcting section and the previously calculated corrected motor torque command base value becomes smaller.

9. The control apparatus for the electrically driven vehicle as claimed in claim 1, which further comprises a motor revolution speed calculating section configured to calculate a revolution speed of the electrically driven motor, wherein the control unit further comprises a vibration suppression control section configured to calculate a vibration suppression command value to suppress a vibration of the electrically driven motor on a basis of the calculated motor revolution speed, and wherein the motor torque variation quantity limitation control section limits the motor torque on a basis of a command value which is an addition of the calculated vibration suppression command value to the calculated motor torque command value

10. A control apparatus for an electrically driven vehicle, comprising:
an accelerator manipulation state detecting section configured to detect an accelerator manipulation state of a driver;
an accelerator manipulated variable detecting section configured to detect an accelerator manipulated variable of the driver;
an electrically driven motor configured to provide a braking torque and a driving torque for road wheels connected via a speed reduction mechanism and a road wheel axle; and
a control unit configured to calculate a motor torque command value to brake and drive the electrically driven motor on a basis of the accelerator manipulated variable detected by the accelerator manipulated variable detecting section, wherein the control unit comprises a motor torque variation quantity limitation control section configured to make smaller an increase gradient of a torque of the electrically driven motor driven on a basis of the motor torque command value than the increase gradient according to the calculated motor torque command value on a basis of the detected accelerator manipulated variable when the torque generated by the electrically driven motor is switched from the torque in a braking direction to the torque in a driving direction.

11. The control apparatus for the electrically driven motor as claimed in claim 10, wherein the motor torque variation quantity limitation control section enlarges an increase quantity per unit time of the torque when the detected accelerator manipulated variable is large as compared with a case where the detected accelerator manipulated variable is small.

12. The control apparatus for the electrically driven motor as claimed in claim 11, which further comprises an accelerator manipulation speed calculating section configured to calculate an accelerator manipulation speed and wherein the motor torque variation quantity limitation control section enlarges the increase quantity per unit time of the torque in a case where the calculated accelerator manipulation speed is high as compared with a case where the calculated accelerator manipulation speed is low.

13. The control apparatus for the electrically driven vehicle as claimed in claim 10, which further comprises a motor revolution speed calculation section configured to calculate a revolution speed of the electrically driven motor, wherein the control unit comprises a motor torque command base value calculating section configured to calculate a motor torque command base value on a basis of the detected accelerator manipulated variable and the calculated motor revolution speed, and wherein the motor torque variation quantity limitation control section limits the calculated motor torque command base value to drive the electrically driven motor.

14. The control apparatus for the electrically driven vehicle as claimed in claim 13, wherein the control unit comprises a motor torque base value correcting section configured to correct the calculated motor torque command base value in accordance with a state of an electrically driven motor driving purpose battery and the motor torque variation quantity limitation control section adds a difference between the motor torque command base value corrected by the motor torque command base value correcting section and the previously calculated corrected motor torque command base value to the previously corrected motor torque command base value to calculate the motor torque command value to limit the torque of the electrically driven motor.

15. The control apparatus for the electrically driven vehicle as claimed in claim 14, wherein the motor torque variation quantity limitation control section decreases the increase gradient of the torque of the electrically driven motor driven on a basis of the motor torque command value as the previously calculated corrected motor torque command value becomes smaller.

16. The control apparatus for the electrically driven vehicle as claimed in claim 15, wherein the motor torque variation quantity limitation control section decreases the increase gradient of the torque of the electrically driven motor driven on a basis of the motor torque command value as a difference between the motor torque command base value corrected by the motor torque command base value correcting section and the previously calculated corrected motor toque command base value becomes smaller.

17. The control apparatus for the electrically driven vehicle as claimed in claim 15, wherein the control unit further comprises a vibration suppression control section configured to calculate a vibration suppression torque command value to suppress a vibration of the electrically driven motor on a basis of the calculated motor revolution speed and wherein the motor torque variation quantity limitation control section limits the increase gradient of the motor torque on a basis of a command value which is an addition of the calculated vibration suppression torque command value to the calculated motor torque command value.

18. A control method for an electrically driven vehicle, the control method driving an electrically driven motor which provides a driving torque for road wheels connected via a speed reduction mechanism and a wheel axle on a basis of an accelerator manipulation state and comprising: providing a braking torque for the road wheel axle when an acceleration manipulation is not carried out from an accelerator manipulation related information detecting section configured to detect an accelerator manipulation related information of a driver and, thereafter, providing a driving torque for the road wheels at an increase gradient smaller than the driving torque when the acceleration manipulation state is transferred to a state in which the accelerator manipulation is carried out.

19. The control method for the electrically driven vehicle as claimed in claim 18, wherein an increase quantity per unit time of the torque is enlarged when the accelerator manipulated variable from the accelerator manipulation related information is large as compared with a case where the accelerator manipulated variable is small.

20. The control method for the electrically driven vehicle as claimed in claim 18, wherein an increase quantity per unit time of the torque is enlarged when an accelerator manipulation speed from the accelerator manipulation related information is high as compared with a case where the accelerator manipulation speed is low.
